(19) United States
(12) Patent Application Publication
(10) Pub. No.: US 2006/0097171 A1
(43) Pub. Date: May 11, 2006

(54) Radiation detection and tracking with GPS-enabled wireless communication system

(76) Inventors: Curt Balchunas, Ayer, MA (US); David A. Rogers, Ayer, MA (US)

Correspondence Address: MAINE & ASMUS, 100 MAIN STREET, P O BOX 3445, NASHUA, NH, 03061-3445, US

(21) Appl. No.: 10/795,659

(22) Filed: Mar. 8, 2004

Related U.S. Application Data
(60) Provisional application No. 60/452,603, filed on Mar. 6, 2003.

(51) Int. Cl. G01T 1/00

(52) U.S. Cl. 250/336.1

(57) ABSTRACT

A nuclear radiation detector included inside mobile personal communication devices (e.g. cellular or satellite phone, pager, PDA) allows for a network of portable radiation detectors that can not only detect radiation, but also track possible radiation sources by virtue of the ubiquitous nature of such personal communication devices. When radiation levels above a certain level are detected, the detector electronics embedded within any proximate mobile personal communication device communicates with the device to cause transmission of relevant data to the authorities (e.g., central reporting server monitored by FBI). The detection event is assessed by factors including, for example, quantity of alarms in a given area and radiation level detected. The small size of this embedded detector allow for its discreet configuration and monitoring at all times. The device is non-invasive and requires no user knowledge or action, thus eliminating indiscriminate and uncontrolled action by the user.

### RELATED APPLICATIONS

This application claims the benefit of U.S. Provisional Application No. 60/452,603, filed Mar. 6, 2003, which is herein incorporated in its entirety by reference.

### FIELD OF THE INVENTION

The invention relates to radiation detection, and more particularly, to the detection and tracking of radiation emitted by the movement of so called “dirty bombs” and other unauthorized nuclear materials.

### BACKGROUND OF THE INVENTION

The threat of a “traditional” nuclear missile attack has existed for many years, and various detection and countermeasure systems have been developed and implemented in the name of protection and deterrence. However, in recent years, threats of nuclear attack by devices such as the “dirty bomb” present a new set of challenges. Such devices, though not as devastating in their effect as traditional nuclear weapons, spew radioactive material, potentially spreading radiation poisoning and hampering relief and cleanup efforts. In addition, such bombs require less technological skill to produce, less nuclear material, and lower grade material. Thus, these bombs pose a significant threat to the public.

Unfortunately, existing radiation detection and countermeasure systems may not be sufficient to mitigate this new threat. In particular, conventional ground-based detection systems tend to be bulky, and are only deployed in limited areas. Unless a detector is sufficiently close to radiation source, the radiation may be indistinguishable from natural background radiation, particularly if the source has been shielded. While government and private agencies have made significant efforts to improve the screening of freight, cargo and luggage, a widespread and discreet defense system including a plurality of radiation detectors would increase the likelihood of discovering dangerous nuclear material so that appropriate actions could be taken.

What is needed, therefore, is a geographically-distributed network of discreet radiation detectors that can readily be deployed to detect, report, and track the existence of radioactive material.

### SUMMARY OF THE INVENTION

One embodiment of the present invention provides a wireless personal communication device configured for radiation detection and tracking. The device includes a wireless personal communication device housing, which includes electronics for wirelessly communicating information to and from the device. A nuclear radiation sensor in included within the housing, and is adapted to provide a detection signal in response to sensing radiation levels above a predefined threshold. A processor also within the housing is adapted to receive the detection signal from the nuclear radiation sensor, and is configured to cause automatic transmission of a detection message to authorities (e.g., FBI or local police) using the electronics. The detection message includes location information of the detection.

Each transmitted detection message may include at least one of the following: radiation level associated with the detection, a sensor-type code indicating the type of event sensed, time of detection, date of detection, and a unique identification number associated with the device. The location information may include, for example, GPS coordinates. The device may be configured, for instance, as one a cell phone, a satellite phone, a pager, a mobile email device (e.g., Blackberry), a personal digital assistant, a tablet, a laptop, or any other electronic device capable of wireless transmission of data to an associated public network without user intervention. The nuclear radiation sensor can be, for example, a Geiger-Mueller tube.

The processor and the nuclear radiation sensor can be powered using a battery included in the electronics of the mobile device, or a dedicated power supply. In one particular case, the nuclear radiation sensor is powered using a battery included in the electronics and a step-up transformer to provide a higher voltage. The device may further include a memory that is accessible by the processor, for storing at least one of a radiation level threshold required for a positive detection, detection response instruction set, emergency telephone numbers for autodialing sequence, frequencies for broadcasting emergency signals, and sensor-type codes that correspond to the different types of events that can be detected by the device.

The processor can be further configured to engage an auto-communications module included in the electronics so as to cause dialing of a predetermined emergency number to which detection messages are sent. The device can be configured real-time by downloading desired programming from the authorities, thereby customizing the device to target detection of a particular threat.

Another embodiment of the present invention provides a method for detecting and tracking radiation using a network of wireless personal communication devices each configured with nuclear radiation sensors. The method includes detecting a nuclear radiation source via a first of the personal communication devices on the network. In response to the detection via the first personal communication device, the method continues with automatically transmitting a first detection message to authorities. This first message includes location information associated with the detection by the first personal communication device. The method further includes detecting the nuclear radiation source via a second of the personal communication devices on the network. In response to this detection via the second personal communication device, the method continues with automatically transmitting a second detection message to authorities. The second message includes location information associated with the detection by the second personal communication device, thereby allowing the authorities to track movement of the nuclear radiation source within the network.

Each transmitted detection message may further include at least one of radiation level associated with the detection, a sensor-type code indicating the type of event sensed, time of detection, date of detection, and a unique identification number associated with the device. The location information included in each detection message may include, for example, GPS coordinates. The detecting can be performed, for example, using a Geiger-Mueller tube. The method may further include a configuration mode that includes downloading at least one of sensor configuration and detection response instructions to one or more of the wireless personal communication devices on the network. The downloaded information may include, for example, at least one of a radiation level threshold required for a positive detection, a detection response instruction set, emergency telephone numbers for autodialing sequence, frequencies for broadcasting emergency signals, and sensor-type codes that correspond to the different types of events that can be detected by the device. The detection messages can be transmitted, for instance, using at least one of cellular, RF, and satellite transmissions. The method may further include receiving each of the detection messages at a central location, processing the detection messages to assess the threat, and in response to a perceived threat, dispatching one or more agents to investigate.

Another embodiment of the present invention provides a method for detecting and tracking radiation using a network of wireless personal communication devices each configured with nuclear radiation sensors. Here, the method includes receiving a first detection message from a first of the personal communication devices on the network. This first detection message indicates detection of a nuclear radiation source and a first geographic location of that source. The method further includes receiving a second detection message from a second of the personal communication devices on the network. The second detection message indicates detection of the nuclear radiation source and a second geographic location of that source. In response to determining that the nuclear radiation source is a threat, the method continues with dispatching one or more agents to investigate.

The method may further include receiving each of the detection messages at a central location, and processing the detection messages to assess the threat. Each received detection message may further indicate at least one of radiation level associated with the detection, a sensor-type code indicating the type of event sensed, time of detection, date of detection, and a unique identification number associated with the device. The geographic location indicated in each detection message can be, for example, GPS coordinates. The method may further include a configuration mode that includes downloading at least one of sensor configuration and detection response instructions to one or more of the wireless personal communication devices on the network. The downloaded information may include, for instance, at least one of a radiation level threshold required for a positive detection, a detection response instruction set, emergency telephone numbers for autodialing sequence, frequencies for broadcasting emergency signals, and sensor-type codes that correspond to the different types of events that can be detected by the device. The detection messages can be received using, for example, at least one of cellular, RF, and satellite transmissions.

Another embodiment of the present invention is a wireless communication device configured for radiation detection and tracking within a cargo container for transporting goods. The device includes a wireless communication device housing that can be placed inside the cargo container. The housing includes electronics for wirelessly transmitting information from the device. A nuclear radiation sensor within the housing is adapted to provide a detection signal in response to sensing radiation levels within the container that are above a predefined threshold. A processor within the housing is adapted to receive the detection signal from the nuclear radiation sensor, and is configured to cause automatic transmission of a detection message to authorities using the electronics. The message includes location information of the detection.

In one such embodiment, the location information includes GPS coordinates. The detection message can be periodically retransmitted with updated location information. The detection message can be transmitted, for example, using existing satellite communication infrastructure. The nuclear radiation sensor can be a Geiger-Mueller tube.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a GPS-enabled wireless personal communication device configured for radiation detection and tracking in accordance with an embodiment of the present invention.

FIG. 2 is a block diagram of a wireless communications network including multiple wireless personal communication devices configured as shown in FIG. 1, the network for detecting and tracking radiation in accordance with an embodiment of the present invention.

FIG. 3 is a detailed block diagram of a GPS-enabled wireless personal communication device configured for radiation detection and tracking in accordance with an embodiment of the present invention

FIG. 4 illustrates a method for detecting and tracking radiation in accordance with an embodiment of the present invention.

### DETAILED DESCRIPTION OF THE INVENTION

Embodiments of the present invention provide a system for detecting possibly hazardous radiation sources, and communicating the location of the radiation source to the proper authorities. In one such embodiment, the system includes a geographically-distributed network of discreet radiation detectors incorporated into GPS-enabled wireless personal communication devices, such as cell phones, satellite phones, pagers, BlackBerries or other mobile email devices, personal digital assistants (PDA), tablets, laptops, and any other electronic device that is or can be configured for wireless transmission of data to an associated public network without user intervention. By exploiting the ubiquitous nature of such electronic wireless devices, a comprehensive network of detection devices is provided that can alert authorities to the existence of radioactive material. In this sense, the invention effectively and harmlessly deputizes millions of citizens to assist the limited number of authorities in preventing an attack.

While one GPS-enabled radiation sensing device may provide only one detection signal, other such devices in the same geographical area will also provide detection signals. Such multiple detection signals in conjunction with corresponding GPS coordinates operate to provide a tracking mechanism. Each detection signal and its corresponding GPS coordinates are automatically transmitted (using existing communication infrastructure) to a central reporting center, thereby allowing the authorities to track and engage the carrier of the radioactive source. In addition, programming instructions and sensor configurations can be transparently downloaded from the central reporting center into memory of each device, thereby allowing authorities to custom tailor the detection and tracking network to a particular threat.

It will be apparent in light of this disclosure that “non-personal” versions of the device can be selectively placed in various locations, such as near building entrance ways and inside cargo containers, thereby providing a similar network of protection. In such an embodiment, the device could be a wireless radiation sensor device having autodial and transmission capability. The devices would have a determinable geographic location (e.g., based on GPS coordinates or simply prior knowledge of its fixed location). The device could be contained, for example, in a small discreet housing that can be secured to a surface in an area to be monitored.

Radiation Sensor Circuit

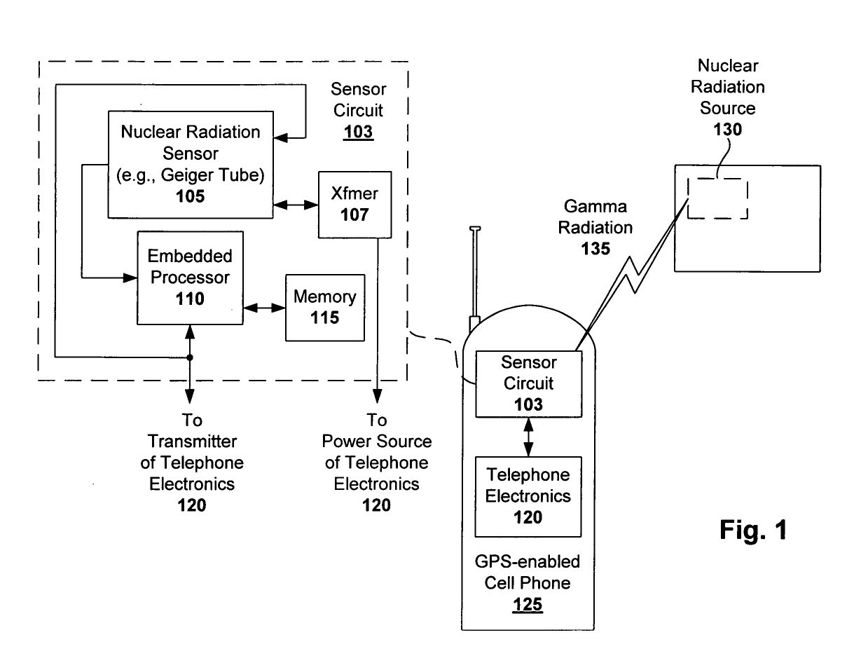

FIG. 1 is a block diagram of a GPS-enabled wireless personal communication device configured for radiation detection and tracking in accordance with an embodiment of the present invention. As can be seen, a cell phone 125 is configured with a sensor circuit 103 as well as conventional GPS-enabled cell phone electronics 120. The sensor circuit 103 is mounted within the housing of cell phone 125 (e.g., on the main printed circuit board of the cell phone or on a daughterboard that is coupled to the main board), and includes a miniature radiation sensor 105 capable of detecting radiation 135 emitted by a radiation source 130. The radiation sensor 105 is coupled to a processor 110 that interfaces the sensor circuit 103 with the transmitter portion of the telephone electronics 120. The processor 110 includes or otherwise has access to a memory 115. Power to the radiation sensor 105 is provided from transformer 107, which is sourced from the power supply of the telephone electronics 120.

Note that GPS-enabled personal communication devices other than cell phones, such as a PDA or pager, can be used for device 125. In this particular example, the radiation sensor 105 is a Geiger-Mueller tube that is capable of detecting of a source of γ radiation, which is typical emission of a “dirty bomb.” Note, however, that the radiation sensor 105 can be implemented with other types of miniature radiation sensors capable of detecting alpha, beta, and gamma nuclear radiation, or any combination thereof. In addition, sensor 105 can be implemented as a combination of sensors that detect nuclear radiation, as well as other characteristics or events.

The incorporation of miniature gamma radiation sensor, such as a conventional Geiger-Mueller tube, allows for a relatively inexpensive detector circuit that will fit within the housing of existing personal communication devices. In general, the shielding of dangerous radiation sources alters the alpha and beta radiation thereby attenuating the gamma radiation. Thus, a radiation source can only be detected by sensors in close proximity. A network of ubiquitous sensing devices as described herein would improve chances of detection. The presence of levels of radiation above normal background would cause the sensing device to notify authorities.

A typical Geiger-Muller tube includes a metal tube that acts as one of the electrodes and is filled with an inert gas and an organic vapor. A thin wire down the center of the cylinder acts as the other electrode. Insulator (e.g., glass) end caps are provided. A voltage supply (e.g., 300-1000 vdc) is applied that is nearly sufficient to cause current flow between the electrodes. This supply can be provided, for example, using miniature step-up transformer 107 in conjunction with the battery included in the electronics 120. Alternatively, a dedicated power supply can be included in the sensor circuit 103. Note that the power scheme will generally depend on the type of sensors used, and that other miniature sensors may be require less or more voltage. When the tube is exposed to gamma radiation, the gas ionizes and the ionized particles carry the current from one electrode to the other. Thus, a Geiger-Muller tube can effectively be used as a switch, which turns-on or conducts current when radiation intensity at a particular level is received.

A radiation source generally emits gamma rays at a level of about 0.5 mR/hr, which is the limit imposed by the Department of Transportation for transport of radioactive materials in unlabeled containers at the surface of a container of one foot diameter. A source would therefore be detectable at a level of about 0.01 mR/hr, at a distance of approximately three feet. A miniature Geiger-Mueller tube is sensitive at a level of about 0.001 mR/hr and the background radiation level is about 0.005 mR/hr. Thus, 0.01 mR/hr is a practical threshold for the detector to issue an alert. In one embodiment, the radiation sensor 105 is a miniature Geiger-Mueller tube, part number G1300 (0501), manufactured by Saint-Gobain.

The current produced by the radiation sensor 105 is provided to the processor 110. In response to this current, the processor 110 can be programmed or otherwise configured to engage an auto-communications feature of the cell phone 125, and to dial a predetermined number (e.g., stored in memory 115) associated with the authorities. The detection and tracking information can be communicated to the authorities by the transmission. Alternatively, the cell phone 125 can broadcast the detection and tracking information during periodic cellular status check sessions, where the status of cell phones (and/or other devices on the network) is checked. The broadcast messages could be sent directly to the authorities, or collected by the network administrator, and then forwarded to the authorities.

The processor 110 can be implemented with a microcontroller or other suitable processing environment that can be configured to receive detection signals and initiate a communication to the authorities. The processor may further include signal processing capability, such as amplification and filtering to minimize the possibility of false detections. The processor 110 may further be configured to receive and respond to other sensor/detection signals as well. For example, the sensor circuit 103 may include sensors for detecting non-nuclear type explosives or related materials, or any prohibited material that has a quality or characteristic that can be detected by a sensory unit small enough to be included in a personal communications device.

The processor 110 can be configured to respond to each type of sensory signal in a particular manner (e.g., notify FBI if nuclear detection; notify local police if gun powder detected). Note that the GPS coordinates can be used to determine if the presence of a particular substance is prohibited or not. For example, certain geographic locations such as arenas, courts, and various other public locations generally don't allow firearms on the premises. The processor 110 could be configured with a table of coordinates where various restrictions apply. Thus, if a restricted activity is sensed in a particular controlled location, the processor will notify authorities. On the other hand, if that same activity is sensed in an uncontrolled location, no notification is given.

Further note that sensing and tracking functionality can be configured real-time, by downloading desired programming from the network administration or central authority to each of the individual devices 125 (i.e., on-the-fly programming of processor 110 and/or any programmable sensors). Thus, in some cases, it will be possible to adjust the sensing and tracking network to target a particular threat.

Detection and Tracking Network

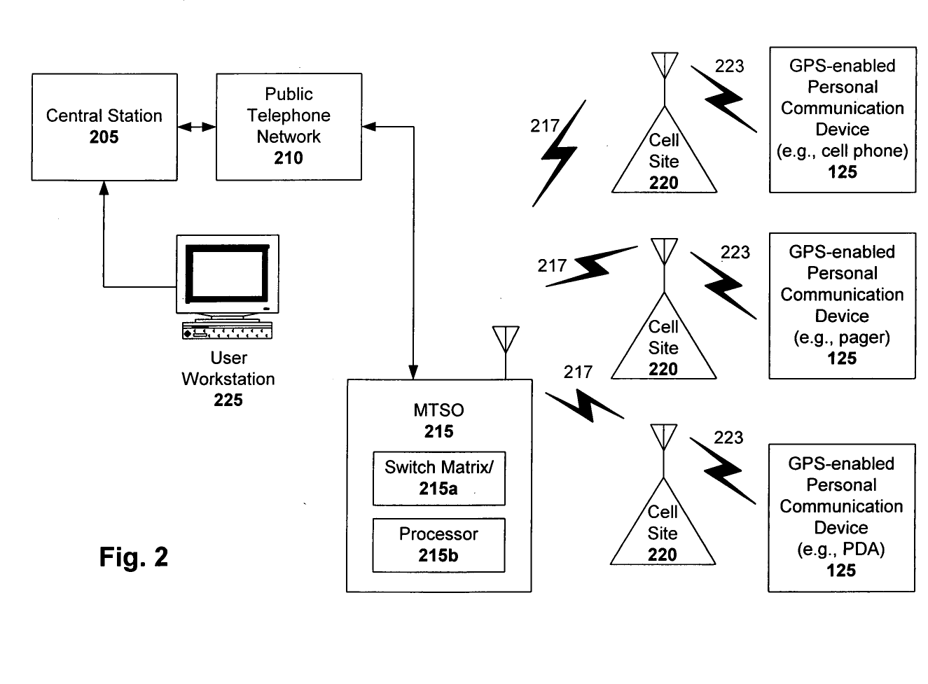

FIG. 2 is a block diagram of a wireless communications network including multiple wireless personal communication devices configured as shown in FIG. 1, the network for detecting and tracking radiation in accordance with an embodiment of the present invention. It will be appreciated in light of this disclosure that there are many variants and hybrid communication systems that can be exploited in accordance with the principle of the present invention. The cellular-based communication system shown in FIG. 2 is provided as one example, and is not intended to limit the present invention. Satellite-based and close-range RF communication systems can also be used to carry out embodiments of the present invention.

As discussed in reference to FIG. 1, the mobile detectors 125 incorporate radiation sensors that detect any radioactive source 130 that is of sufficient strength to register with the radiation detection system of the mobile detectors 125. The mobile detectors 125 can be, for example, any combination of cell phones, satellite phones, pagers, PDAs, BlackBerries, laptops, etc. Such a network can cover large geographic areas as the prevalent mobile detectors 125 are continuously moving and difficult to evade. The detection network can be used in conjunction with other hidden, non-personal, and/or stationary sensors to raise the authenticity and prevent false alarms, as well as improve the overall robustness of area defense.

Once the sensor of a mobile detector 125 detects a radioactive source 130, it automatically sends out a signal 223 which is generally picked up at a base station or cell site 220. The transmitted signal 223 includes certain information, such as date/time of detection, geographic location of phone (e.g., GPS coordinates), and the strength/type of signal detected. Note that numerous conventional transmission protocols that allow an outgoing wireless signal 223 to be picked up in a variety of formats including cell formats, satellite, and paging. There are also FCC bandwidths especially reserved for emergency broadcasts which can be used to transmit signal 223. The signal 223 received at the cell site 220 is then dispatched or relayed as an outgoing signal 217 to a mobile telephone switching office (MTSO) 215.

The MTSO 215 can receive the signal 217 by wireless or wired means as conventionally done. The MTSO 215 incorporates a switching matrix 215a that is switchably coupled to numerous cell sites 220 as well as the public telephone network 210. The user signal 223 typically contains a user mobile identification number, and an electronic serial number would be transmitted to the MTSO 215. A processor 215b included in the MTSO 215 is configured to identify the incoming user and signal 217, and to route the signal 217 according to pre-defined guidelines to a variety of resources. For example, calls from mobile detectors 125 can be forwarded via existing infrastructure to a central call center, a nearby mobile unit, or emergency response team. Thus, processor 215b can be further configured to selectively forward messages from the mobile detectors 125 directly to authorities.

For example, processor 215b of the MTSO could be provided with instructions to bypass the normal cellular call process and automatically process calls that originate from certain mobile identification numbers (indicating devices configured as mobile detectors 125) having a particular mobile identification code (indicating a detection and tracking information is included in the message being transmitted). Thus, automatic calls from mobile detectors 125 that have triggered because of proximity to radioactive material would be given priority processing for rapid response and analysis.

In the example shown, a central alarm station 205 is equipped with computers capable of compiling data from a plurality of mobile detectors 125. In such an embodiment, MTSO 215 needs no special configuration. The MTSO 215 dispatches the information from mobile detectors 125 to the central station 205 for further processing. A user would be able to analyze the data on a workstation 225, and make additional decisions as to emergency response.

As previously explained, the information from the detectors 125 may include, for example, GPS location data and intensity of the radiation signature detected. However, other sensory data may be communicated as well. In response to the detection and GPS coordinate information received, the central alarm station 205 can precisely identify the path and location of the detected radiation source, and direct agents to inspect, seize, and contain the source.

Mobile Detector Architecture

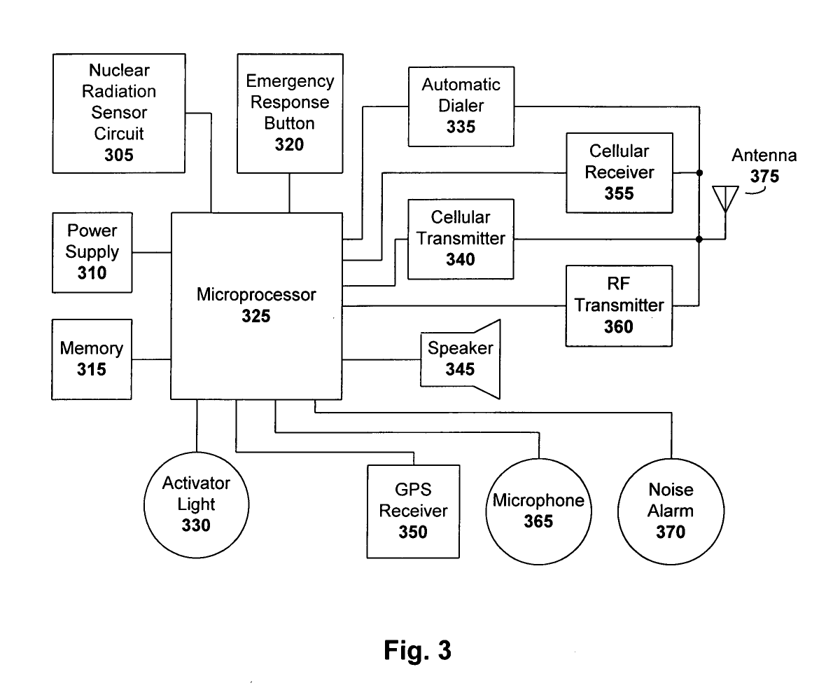

FIG. 3 is a detailed block diagram of a GPS-enabled wireless personal communication device configured for radiation detection and tracking in accordance with an embodiment of the present invention. The device includes a radiation sensor 305, a power supply 310, a memory 315, an emergency response button 320, a microprocessor 325, an activator light 330, an automatic dialer module 335, a cellular transmitter 340, a speaker 345, a global positioning satellite (GPS) receiver module 350, a cellular receiver 355, an RF transmitter 360, a microphone 365, a noise alarm 370, and an antenna 375. Each of components 310 through 375 can be implemented with conventional technology. The radiation sensor circuit 305 can be configured, for example, as discussed in reference to FIG. 1.

Note, however, that the functionality of the processor 110 can be integrated into microprocessor 325. Likewise, memory 115 can be replaced by, or used in addition to memory 315. Numerous other configurations will be apparent in light of this disclosure, and the componentry that makes up the GPS-enabled wireless personal communication device will vary depending on factors such as the type of device and the relevant transceiver protocols. In any such cases, nuclear radiation sensor circuit 305 is provided within the housing of the device, and triggers when in close proximity to radioactive material. The device then automatically reports pertinent information regarding the trigger event (e.g., location and radiation level).

The antenna 375 provides the wireless transmission and reception capabilities for the device, and is switchably coupled to both transmitters 340 and 360 as well as receiver 355. The automatic dialing module 335 is also coupled to the antenna 375, to enable various communications without user interface. The use of RF transmitter 360 and cellular transmitter 355 allows for transmissions in multiple formats/protocols. For example, the RF transmitter 360 can send out a signal that is picked up by an internal security system such as a large building or within a local perimeter. The cellular transmitter 355 sends the signal to the cell sites as conventionally done.

The cellular receiver 355 picks up signals from the antenna 375, and if appropriate, transfers the incoming signal to the microprocessor 325. The microprocessor 325 is coupled to a power supply 310, and is the processing unit for the device. In particular, the microprocessor 325 controls the operations of the various features of the receiver 355. The memory 315 may be configured, for example, with both RAM and ROM portions, and includes firmware that allows certain functions to follow predefined instructions, such as autodialing using the automatic dialer module 335 if the radiation sensor circuit 305 indicates that the sensor therein has detected some radiation source sufficient to trigger an alert.

The GPS receiver 350 provides a geographic location of the device, which can be stored in memory 315 and refreshed at continuing intervals (e.g., every 5 to 30 seconds). The currently stored GPS data is transmitted by one or both of the transmitters 340 and 360 in conjunction with the automatic dialer 335 once the radiation detector circuit 275 signals a radiation source has been detected. While the GPS receiver 350 provides an efficient mechanism for geographic location implementation, there are a number of other schemes that can be used here to identify geographic location of the device. For example, smart antennas and algorithms that process the received signal from one or more cell sites can provide geographic location data.

The basic functionality of a device generally includes the speaker 345 and microphone 365, which allow the user to communicate with other parties. The device can include a number of options and accessories depending upon the specific user requirements. An activator light 330 could provide a silent alert for the device owner that a radiation source was detected. A noise alarm 370 is also an option to alert the owner, which can have a silent mode option (e.g., vibration mode) to prevent audible alerts. The device can also include an emergency response button 320 that could transmit an emergency signal upon activation of the button 320. The emergency alarm button 320 sends a signal to the microprocessor 325 which activates the automatic dialer 335. The automatic dialer 335 then dials the number of the emergency response center or other authorities. Note, however, that it may be preferable for the device to remain non-invasive and require no user knowledge or action, thus eliminating indiscriminate and uncontrolled action by the user. If such is the case, then optional features such as the activator light 330, noise alarm 370, and emergency response button 320 would simply not be included in the design.

For cost considerations, however, note that the features of the device can be pared down to provide a GPS-enabled wireless radiation sensor device having autodial and transmission capability. In addition, note that the device need not be limited to a personal communications device. As previously explained, “non-personal” versions of the device can be selectively placed in various locations, such as near building entrance ways and inside cargo containers, thereby giving rise to a number of detection and signalling protection schemes.

Consider, for example, deploying one or more wireless radiation sensor devices having autodial and transmission capability inside each cargo container (e.g., ship, train, tractor trailer) shipped into the country. If a nuclear radiation source was introduced into the container, a sensor device therein would detect and automatically communicate the detection to the authorities (e.g., using a predefined satellite communication channel). The devices would have a determinable geographic location (e.g., based on GPS coordinates) that would be transmitted as well. Note that periodically re-sending the detection with updated coordinates provides a tracking feature as well. Thus, processor 325 could be so configured (e.g., resend every 15 minutes)

Such a sensor device would be particularly useful in “fast-tracking” incoming cargo that is required to be confirmed as threat-free before being released into the normal commerce channels. Currently, incoming cargo must pass through large scanning machines to be checked-out. This checkpoint significantly delays the flow of the “quarantined” goods into commerce. However, if a container is shipped with a sensor configured in accordance with the principles of the present invention, then the goods within that container could be fast-tracked into commerce, assuming the sensor device was not triggered (e.g., as indicated by green and red LEDs; green for ok, red for threat). In such applications, the sensor device could be contained within a tamper-resistant housing, if so desired.

Methodology

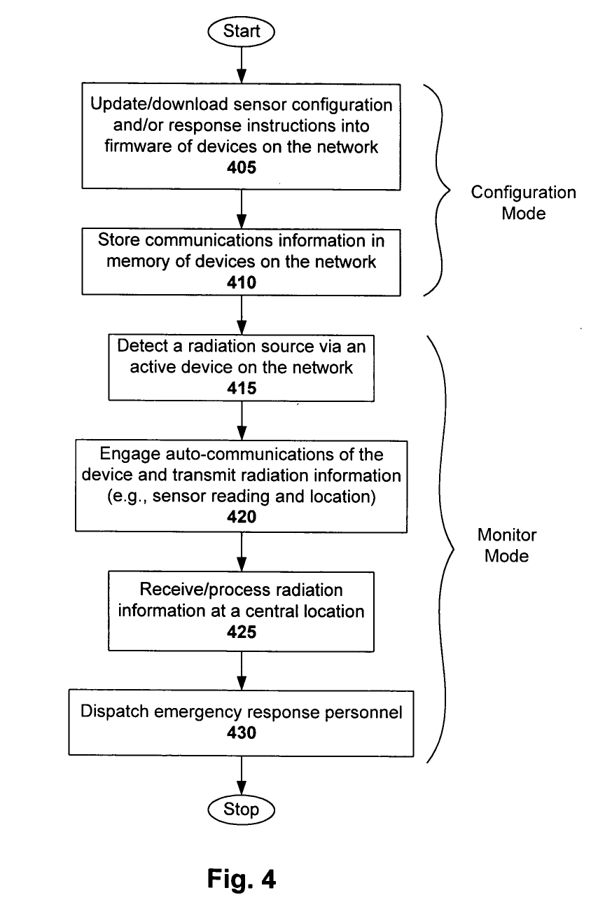

FIG. 4 illustrates a method for detecting and tracking radiation in accordance with an embodiment of the present invention. The method can be carried out for example, in the context of the network discussed in reference to FIG. 2, where any number (e.g., hundreds to millions) of GPS-enabled mobile sensing device configured for radiation detection and tracking are included in the network. The method could also be implemented in the context of a network of selectively placed “non-personal” GPS-enabled sensing devices (e.g., cargo container application). As can be seen, this particular detecting and tracking method includes two modes: a configuration mode and a monitor mode.

During configuration mode, the method includes downloading 405 sensor configuration and/or detection response instructions into firmware of devices on the network. Such downloads can take place on an as needed basis as part of a regular update and maintenance plan, or can be performed to customize the detection and tracking network to target a particular threat. For example, the radiation level threshold required to cause a positive detection signal to be sent can be lowered to enable a more aggressive detection network. Note that such downloads can be generally broadcast to all devices on the network, or selectively transmitted to one or more target devices (e.g., based on device ID numbers).

The configuration mode of the method further includes storing 410 downloaded communications information into memory of the GPS-enabled mobile sensing devices. Such information includes, for example, radiation level threshold required for a positive detection, detection response instruction set, and emergency telephone numbers for autodialing sequence or frequencies for broadcasting emergency signals. In addition, sensor-type codes could be stored, which correspond to the different types of events that can be detected by a mobile detection device on the network. Thus, an emergency communication triggered by a particular sensor or event can include the corresponding sensor-type code, thereby giving authorities more information as the nature of the sensed threat.

In the monitor mode, the network of GPS-enabled mobile sensing devices is configured and essentially waiting for a target sensory event to occur, such as detection of a dirty bomb. Here, the method may include detecting 415 a radiation source via an active device on the network. Other detections may also be made, as previously explained. In response to such detections, the method continues with engaging 420 auto-communications of the mobile sensing device, and transmitting radiation information associated with the triggering event, such as the sensor reading, sensor-type code, time/date, and geographic location at time of detection.

Recall that prior to a detection, a Geiger-Mueller tube doesn't conduct. Thus, the draw on battery power of the device is fairly typical. In addition, the sensing itself does not require much electrical power. In any event, once a threshold level of radiation is detected, an event is triggered by the radiation sensing circuit which issues a signal to the microprocessor of the GPS-enable mobile device. The microprocessor then follows the firmware instructions to engage the auto-communications and send the pertinent radiation information.

Note that the geographic location of a triggered mobile sensor device can be determined using a number of techniques, including a GPS receiver, triangulation algorithms, and limiting location of a particular mobile sensor device to a known geographic area. In this sense, the mobile sensor devices on the network have a determinable geographic location. Further note that the auto-communications can be carried out by one or more transmission types, such as cellular, RF, and satellite transmissions.

The method continues with receiving and processing 425 the radiation information. The radiation information can be received, for example, at a central location or other predefined authority. Here, the central location processing may include assessing the sensed event (e.g., type of radiation and strength), identification data of the sending device, and geographic location. If the deemed appropriate, the method may continue with dispatching 430 an emergency response team. The information may also be transmitted to other personnel for backup and response.

The foregoing description of the embodiments of the invention has been presented for the purposes of illustration and description. It is not intended to be exhaustive or to limit the invention to the precise form disclosed. For example, note that mobile personal communication devices in which a radiation sensor can be integrated into further include police portable radios, walkie-talkies and similar communications devices employed by civil servants, security personnel and armed forces that are providing protection. Many modifications and variations are possible in light of this disclosure. It is intended that the scope of the invention be limited not by this detailed description, but rather by the claims appended hereto.

What is claimed is:

1. A wireless personal communication device configured for radiation detection and tracking, comprising:
a wireless personal communication device housing, including electronics for wirelessly communicating information to and from the device;
a nuclear radiation sensor within the housing, and adapted to provide a detection signal in response to sensing radiation levels above a predefined threshold; and
a processor within the housing, and adapted to receive the detection signal from the nuclear radiation sensor, and configured to cause automatic transmission of a detection message to authorities using the electronics, the message including location information of the detection.

2. The device of claim 1 wherein each transmitted detection message further includes at least one of radiation level associated with the detection, a sensor-type code indicating the type of event sensed, time of detection, date of detection, and a unique identification number associated with the device.

3. The device of claim 1 wherein the location information includes GPS coordinates.

4. The device of claim 1 wherein the device is further configured as one a cell phone, a satellite phone, a pager, a mobile email device, a personal digital assistant, a tablet, or a laptop.

5. The device of claim 1 wherein the nuclear radiation sensor is a Geiger-Mueller tube.

6. The device of claim 1 wherein the processor and the nuclear radiation sensor are powered using a battery included in the electronics.

7. The device of claim 1 wherein the nuclear radiation sensor is powered using a battery included in the electronics and a step-up transformer.

8. The device of claim 1 further comprising a memory accessible by the processor, and for storing at least one of a radiation level threshold required for a positive detection, detection response instruction set, emergency telephone numbers for autodialing sequence, frequencies for broadcasting emergency signals, and sensor-type codes that correspond to the different types of events that can be detected by the device.

9. The device of claim 1 wherein the processor is further configured to engage an auto-communications module included in the electronics so as to cause dialing of a predetermined emergency number to which the detection message is sent.

10. The device of claim 1 wherein the device can be configured real-time by downloading desired programming from the authorities, thereby customizing the device to target detection of a particular threat.

11. A method for detecting and tracking radiation using a network of wireless personal communication devices each configured with nuclear radiation sensors, comprising:
detecting a nuclear radiation source via a first of the personal communication devices on the network;
in response to the detection via the first personal communication device, automatically transmitting a first detection message to authorities, the first message including location information associated with the detection by the first personal communication device;
detecting the nuclear radiation source via a second of the personal communication devices on the network; and
in response to the detection via the second personal communication device, automatically transmitting a second detection message to authorities, the second message including location information associated with the detection by the second personal communication device, thereby allowing the authorities to track movement of the nuclear radiation source within the network.

12. The method of claim 11 wherein each transmitted detection message further includes at least one of radiation level associated with the detection, a sensor-type code indicating the type of event sensed, time of detection, date of detection, and a unique identification number associated with the device.

13. The method of claim 11 wherein the location information included in each detection message includes GPS coordinates.

14. The method of claim 11 wherein the detecting is performed using a Geiger-Mueller tube.

15. The method of claim 11 wherein the method further includes a configuration mode, comprising:
downloading at least one of sensor configuration and detection response instructions to one or more of the wireless personal communication devices on the network.

16. The method of claim 15 wherein downloaded information includes at least one of a radiation level threshold required for a positive detection, a detection response instruction set, emergency telephone numbers for autodialing sequence, frequencies for broadcasting emergency signals, and sensor-type codes that correspond to the different types of events that can be detected by the device.

17. The method of claim 12 wherein the detection messages are transmitted using at least one of cellular, RF, and satellite transmissions.

18. The method of claim 12 further comprising:
receiving each of the detection messages at a central location;
processing the detection messages to assess the threat; and
in response to a perceived threat, dispatching one or more agents to investigate.

19. A method for detecting and tracking radiation using a network of wireless personal communication devices each configured with nuclear radiation sensors, comprising:
receiving a first detection message from a first of the personal communication devices on the network, the first detection message indicating detection of a nuclear radiation source and a first geographic location of that source;
receiving a second detection message from a second of the personal communication devices on the network, the second detection message indicating detection of the nuclear radiation source and a second geographic location of that source; and
in response to determining that the nuclear radiation source is a threat, dispatching one or more agents to investigate.

20. The method of claim 19 further comprising:
receiving each of the detection messages at a central location; and
processing the detection messages to assess the threat.

21. The method of claim 19 wherein each received detection message further indicates at least one of radiation level associated with the detection, a sensor-type code indicating the type of event sensed, time of detection, date of detection, and a unique identification number associated with the device.

22. The method of claim 19 wherein the geographic location indicated in each detection message is GPS coordinates.

23. The method of claim 19 wherein the method further includes a configuration mode, comprising:
downloading at least one of sensor configuration and detection response instructions to one or more of the wireless personal communication devices on the network.

24. The method of claim 23 wherein downloaded information includes at least one of a radiation level threshold required for a positive detection, a detection response instruction set, emergency telephone numbers for autodialing sequence, frequencies for broadcasting emergency signals, and sensor-type codes that correspond to the different types of events that can be detected by the device.

25. The method of claim 19 wherein the detection messages are received using at least one of cellular, RF, and satellite transmissions.

26. A wireless communication device configured for radiation detection and tracking within a cargo container for transporting goods, comprising:
a wireless communication device housing that can be placed inside the cargo container, including electronics for wirelessly transmitting information from the device;
a nuclear radiation sensor within the housing, and adapted to provide a detection signal in response to sensing radiation levels above a predefined threshold; and
a processor within the housing, and adapted to receive the detection signal from the nuclear radiation sensor, and configured to cause automatic transmission of detection message to authorities using the electronics, the message including location information of the detection.

27. The device of claim 26 wherein the location information includes GPS coordinates.

28. The device of claim 26 wherein the detection message is periodically retransmitted with updated location information.

29. The device of claim 26 wherein the detection message is transmitted using existing satellite communication infrastructure.

30. The device of claim 26 wherein the nuclear radiation sensor is a Geiger-Mueller tube.
